(19) United States
(12) Patent Application Publication
(10) Pub. No.: US 2024/0362540 A1
(43) Pub. Date: Oct. 31, 2024

(54) SYSTEM AND METHOD USING MACHINE LEARNING MODEL FOR HEALTHCARE MONITORING

(71) Applicant: Healthy Engage LLC, Frisco, TX (US)

(72) Inventor: Ravi Seshadri, Frisco, TX (US)

(21) Appl. No.: 18/646,538

(22) Filed: Apr. 25, 2024

Related U.S. Application Data
(60) Provisional application No. 63/498,869, filed on Apr. 28, 2023.

(51) Int. Cl. G06N 20/00

(52) U.S. Cl. CPC G06N 20/00

(57) ABSTRACT

A system includes at least one device configured to extract data from at least one internet-connected data source and preprocess the extracted data. The system also includes a database configured to store the preprocessed data. The system also includes at least one processor configured to perform vector extraction to extract features of at least a portion of the preprocessed data and generate a plurality of vectors from the extracted features of the preprocessed data, input the plurality of vectors into a machine learning model trained using historical data from the at least one internet-connected data source, and generate, using the machine learning model and the plurality of vectors, a willingness signature associated with an individual, wherein the willingness signature is a numerical value or a probability distribution that represents a propensity of the individual to engage in healthcare-related activities.

### CROSS-REFERENCE TO RELATED APPLICATION AND PRIORITY CLAIM

This application claims priority under 35 U.S.C. § 119(e) to U.S. Provisional Patent Application No. 63/498,869 filed on Apr. 28, 2023, which is hereby incorporated by reference in its entirety.

### TECHNICAL FIELD

This disclosure relates generally to machine learning systems. More specifically, this disclosure relates to a system and method using machine learning model for healthcare monitoring.

### BACKGROUND

The healthcare industry is rapidly evolving and so are the options available to support it. However, current technological systems for monitoring patients and aspects of their healthcare are antiquated and rely on incomplete data and poor decision-making solutions.

### SUMMARY

This disclosure relates to a system and method using machine learning model for healthcare monitoring.

In one example embodiment, a system includes at least one device configured to receive data from an internet-connected data source, a processor configured to execute a computer program to analyze the received data, a database configured to store the results of the analysis, and a network connection between the processor and a provider that allows the provider to access the results.

In one or more of the above examples, the data received from the internet-connected data source includes healthcare finance data from healthcare encounters and non-healthcare financial data associated with an individual.

In one or more of the above examples, the processor is further configured to convert the data into a financial record of the consumer, extract a plurality of vectors from the financial data, generate a willingness signature of the consumer from the plurality of vectors, monitor the plurality of vectors over time, generate a longitudinal financial record of the consumer, and cause a display of the financial record, the financial signature, and the longitudinal financial record of the consumer.

In another example embodiment, a method for continuous monitoring includes determining a health threshold value. The method also includes monitoring the health of an individual by determining if a current status of the individual is within a range between the health threshold value and a lower limit. The method also includes informing at least one consumer of the current status of the individual when it is determined that their current financial status is within a range between the financial health threshold value and a lower limit.

In another example embodiment, a system includes at least one device configured to extract data from at least one internet-connected data source and preprocess the extracted data, including performance of one or more of a transformation of the extracted data, a filtering of the extracted data, a modification of the extracted data, and a standardization of the extracted data. The system also includes a database configured to store the preprocessed data. The system also includes at least one processor configured to perform vector extraction to extract features of at least a portion of the preprocessed data and generate a plurality of vectors from the extracted features of the preprocessed data. The at least one processor is also configured to input the plurality of vectors into a machine learning model trained using historical data from the at least one internet-connected data source. The at least one processor is also configured to generate, using the machine learning model and the plurality of vectors, a willingness signature associated with an individual, wherein the willingness signature is a numerical value or a probability distribution that represents a propensity of the individual to engage in healthcare-related activities.

In one or more of the above examples, the at least one processor is further configured to perform longitudinal record monitoring on the plurality of vectors over time generate a longitudinal record of the individual based on the longitudinal record monitoring.

In one or more of the above examples, the at least one processor is further configured to detect, based on the longitudinal record monitoring, updates to the plurality of vectors and retrain the machine learning model using the updates to the plurality of vectors.

In one or more of the above examples, the at least one processor is further configured to issue a real-time notification to one or more third parties based on the detected updates to the plurality of vectors.

In one or more of the above examples, the system further includes a network connection between the at least one processor and another device that allows the other device to request access to the willingness signature and the longitudinal record, and the at least one processor is further configured to receive a request by the other device to access the longitudinal record and generate a visual display of the longitudinal record and the willingness signature to the other device.

In one or more of the above examples, the at least one processor is further configured to provide to the other device, using the willingness signature, one or more of personalized recommendations, feedback, trend analysis, score adjustments, and real-time data monitoring updates.

In one or more of the above examples, the at least one processor is further configured to cause the preprocessed data to be stored using a blockchain network.

In one or more of the above examples, the preprocessing of the extracted data includes using a natural language processing model having access to a document data store to perform automated data augmentation and data enrichment on the extracted data.

In one or more of the above examples, to generate the willingness signature, the machine learning model is configured to perform at least one of feature classification, data clustering, and linear or logistic regression.

In one or more of the above examples, the at least one processor is further configured to determine a health threshold value based on the longitudinal record, monitor the health of the individual via a determination of whether a current status of the individual is within a range between the health threshold value and a lower limit, and inform the other device of the current status of the individual when it is determined that the current status is within the range between the health threshold value and the lower limit.

In another example embodiment, a method includes extracting data from at least one internet-connected data source and preprocessing the extracted data, including performing one or more of a transformation of the data, a filtering of the data, a modification of the data, and a standardization of the data. The method also includes storing the preprocessed data in a database. The method also includes performing vector extraction to extract features of at least a portion of the preprocessed data and generating a plurality of vectors from the extracted features of the preprocessed data. The method also includes inputting the plurality of vectors into a machine learning model trained using historical data from the at least one internet-connected data source. The method also includes generating, using the machine learning model and the plurality of vectors, a willingness signature associated with an individual, wherein the willingness signature is a numerical value or a probability distribution that represents a propensity of the individual to engage in healthcare-related activities.

In one or more of the above examples, the method also includes performing longitudinal record monitoring on the plurality of vectors over time and generating a longitudinal record of the individual based on the longitudinal record monitoring.

In one or more of the above examples, the method also includes detecting, based on the longitudinal record monitoring, updates to the plurality of vectors and retraining the machine learning model using the updates to the plurality of vectors.

In one or more of the above examples, the method also includes issuing a real-time notification to one or more third parties based on the detected updates to the plurality of vectors.

In one or more of the above examples, the method also includes allowing a device to request access to the willingness signature and the longitudinal record via a network connection, receiving a request by the device to access the longitudinal record, and generating a visual display of the longitudinal record and the willingness signature to the device.

In one or more of the above examples, the method also includes providing to the device, using the willingness signature, one or more of personalized recommendations, feedback, trend analysis, score adjustments, and real-time data monitoring updates.

In one or more of the above examples, the method also includes causing the preprocessed data to be stored using a blockchain network.

In one or more of the above examples, the preprocessing of the extracted data includes using a natural language processing model having access to a document data store to perform automated data augmentation and data enrichment on the extracted data.

In one or more of the above examples, generating the willingness signature includes performing, using the machine learning model, at least one of feature classification, data clustering, and linear or logistic regression.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch).

Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as APPLETV or GOOGLE TV), a smart speaker or speaker with an integrated digital assistant (such as APPLE HOMEPOD or AMAZON ECHO), a gaming console (such as an XBOX, PLAYSTATION, or NINTENDO consoles), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates a machine learning diagnostics system in accordance with this disclosure;

FIG. 3 illustrates an example method for machine learning diagnostics in accordance with this disclosure;

FIG. 4 illustrates an example machine learning healthcare scoring system in accordance with this disclosure;

FIG. 5 illustrates an example method for machine learning healthcare scoring in accordance with this disclosure;

FIG. 6 illustrates an example machine learning healthcare monitoring system in accordance with this disclosure; and

FIG. 7 illustrates an example method for machine learning healthcare monitoring in accordance with this disclosure.

### DETAILED DESCRIPTION

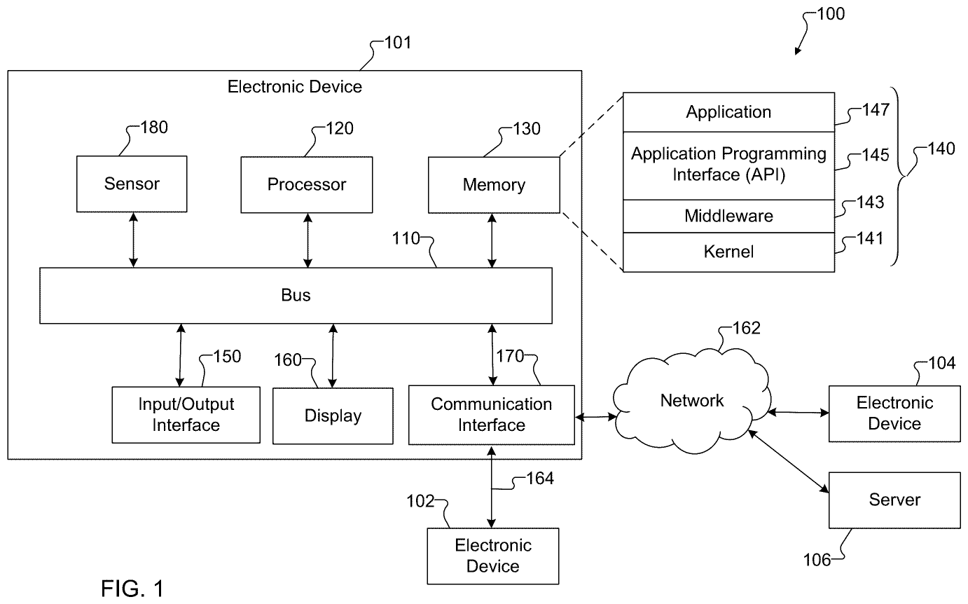

FIGS. 1 through 7, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, the healthcare industry is rapidly evolving and so are the options available to support it. However, current technological systems for monitoring patients and aspects of their healthcare are antiquated and rely on incomplete data and poor decision-making solutions. With new technology, there are new opportunities to create a healthcare monitoring framework that can provide real-time insights into the healthcare related issues for consumers.

In various embodiments, this disclosure provides an artificial intelligence-powered computerized decision support system for designing, managing and executing, among other things, financial disposition in healthcare. Various embodiments specifically focus on individual healthcare consumers' financial disposition. By creatively integrating artificial intelligence (AI) and machine learning (ML) techniques, this innovative system aims to optimize healthcare financial decision-making by intelligently analyzing healthcare consumers' data, commonly prevalent treatment options in the industry, and the associated resources and costs of those treatment options. This system includes computerized decision support system for designing, managing and executing financial segments.

In various embodiments, the system includes a database comprising collected data regarding patients, commonly prevalent treatment practices, and required resources and costs associated therewith, an editing tool for adding information to the database and editing information collected within the database, and a decision management tool for managing financial decisions executed according to a willingness, spend and propensity scores. In some embodiments, the system can be used for continuous monitoring of financial health, such as via the steps of determining a financial health threshold value, monitoring the financial health of an individual by determining if the current financial status of the individual is within a range between the financial health threshold value and a lower limit, and informing at least one consumer of the current financial status of the individual when it is determined that their current financial status is within a range between the financial health threshold value and a lower limit. In various embodiments, the system also includes a device that receives data from an internet-connected device belonging to an individual, a processor that runs a computer program to analyze the received data, a database that stores the results of the analysis, and a connection between the processor and a provider that allows the provider to access the results. The invention is a healthcare financial diagnostic system and method that can be used by a consumer to continuously monitor their personal finances.

In various embodiments, the system can also allow for a consumer to provide data relating to their financial health, including the total amount of money they have saved and the total amount they owe. The consumer also provides data relating to their current financial situation, including the amount they spend each month on bills and expenses, and whether or not they have any loans or debts. The system retrieves this data from multiple sources, including banks, credit card companies, insurance companies, and other institutions that hold information on the consumer's finances. The system then analyzes this data using machine learning algorithms to determine whether or not the consumer has any debt or loans (and if so, how much), as well as how much money they have saved up in savings accounts (and if so, how much). Additionally, if there are any discrepancies between what was reported by different institutions (such as when two banks report different amounts of debt owed), then these discrepancies are identified by analyzing all reported information together before proceeding with further calculations.

In various embodiments, this disclosure also provides a computerized decision support system for acquiring, normalizing and computing a healthcare financial scoring model (“willingness score”) for a consumer of healthcare services, based on their social, financial, environmental, demographic, work history, healthcare related activities and other online behaviors. The system leverages advanced AI techniques, blockchain technology, and data organization algorithms to acquire, normalize, and analyze data from various data sources. This system can include a computerized decision support system for acquiring, normalizing and computing a willingness score for an individual based on their social, financial, environmental, demographic, work history, healthcare related activity and other online behaviors.

In various embodiments, this disclosure also provides an AI-driven system and method for monitoring healthcare finance in a network environment. The system integrates blockchain technology, real-time notifications, and advanced data processing techniques to manage and analyze healthcare financial data and non-healthcare financial data associated with a healthcare consumer. In various embodiments, the system is able to track spending across all facets, that are directly related to healthcare or other financial activities that impact spending in healthcare. The system is also able to integrate with existing infrastructure(s) and has the ability to generate insights that can be used by decision-makers to make informed choices about the impact of that spending related to their relationship to the consumer. Such a system provides substantial benefits. With real-time data available on spending patterns, healthcare organizations would be able to make more informed decisions about where to invest their resources, leading to more efficient and effective use of resources, and ultimately, better patient outcomes. In operation, for example, this system can receive data from a source, where the data includes healthcare finance data (from encounters) and non-healthcare financial data associated with an individual, converting the data into a financial record of the consumer, extract a plurality of vectors from the financial data, and generate a willingness signature of the consumer from the plurality of vectors, monitor the plurality of vectors over time and generating a longitudinal financial record of the consumer, and display the financial record, the financial signature and the longitudinal financial record of the consumer.

It will be understood that the above described systems can be separately deployed, or can be all a part of a single system or networked platform.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals, such as images.

The electronic device 101 further includes one or more sensors 180 that can meter a physical quantity or detect an activation state of the electronic device 101 and convert metered or detected information into an electrical signal. The sensor(s) 180 can also include The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

The first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more cameras.

The wireless communication is able to use at least one of, for example, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a cellular communication protocol. The wired connection can include, for example, at least one of a universal serial bus (USB), high definition multimedia interface (HDMI), recommended standard 232 (RS-232), or plain old telephone service (POTS). The network 162 includes at least one communication network, such as a computer network (like a local area network (LAN) or wide area network (WAN)), Internet, or a telephone network.

The first and second external electronic devices 102 and 104 and server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith.

The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101.

Although FIG. 1 illustrates one example of a network configuration 100 including an electronic device 101, various changes may be made to FIG. 1. For example, the network configuration 100 could include any suitable number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

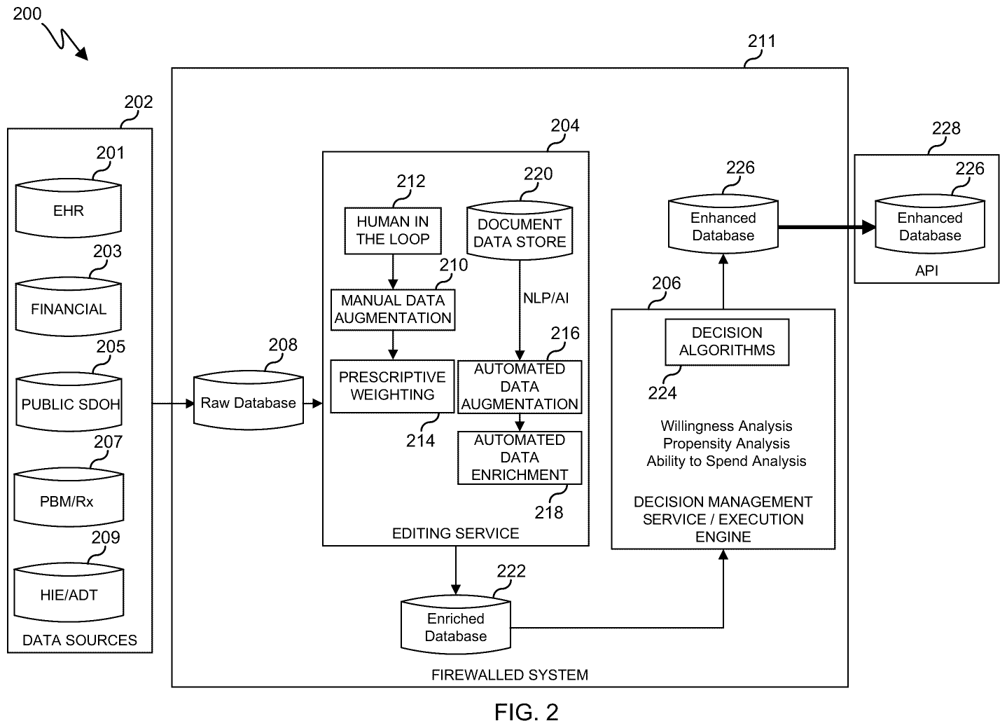

FIG. 2 illustrates a machine learning diagnostics system 200 in accordance with this disclosure. For ease of explanation, the system 200 is described as involving the use of the electronic device 101 in the network configuration 100 of FIG. 1 and/or one or more servers 106. However, the system 200 may be used with any other suitable electronic device(s) and in any other suitable system(s), such as when the system 200 is implemented on or supported by the server 106.

As shown in FIG. 2, the system 200 includes one or more sources 202 such as databases that store collected data/information regarding healthcare consumers (individuals). These data sources 202 can include an electronic healthcare records (HER) database 201, a financial database 203, a public social detriments of health (SDOH) database 205, a pharmacy benefit managers and/or prescriptions database 207, and/or a health information exchange (HIE) and/or admissions, discharge, transfer (ADT) database 209. The data sources 202 can include (i) medical history, demographics, and healthcare insurance information, (ii) commonly prevalent treatment practices, the required resources for these treatments, and the associated costs for these treatments, and (iii) proprietary AI algorithms/models employed to detect patterns and trends in the collected data, allowing for more accurate predictions and personalized (to the healthcare consumer/individual) financial diagnostics.

The system 200 also includes an editing service 204 that provides a user-friendly editing tool to allow healthcare (Provider, Payor, Life Sciences) professionals and administrators to (i) add new information or edit existing information to the above database and (ii) employ AI-driven natural language processing (NLP) techniques to analyze unstructured data, such as medical records, and extract relevant information to be stored in the database. This ensures that the database remains up-to-date and relevant, allowing for accurate financial diagnostics and decision-making.

The system 200 also includes a decision management service or execution engine 206, which is a sophisticated AI-powered model that uses advanced analytics, machine learning algorithms, and AI-driven simulations to analyze the data in the enriched database 222 and generate personalized financial diagnostics and recommendations for each patient. Financial decision support is based on various factors, such as a healthcare consumers' (i) willingness to undergo specific treatments, (ii) ability to spend, and (iii) propensity to adhere to prescribed treatment plans.

The system 200 leverages AI and ML techniques to, for example, identify cost-effective treatment options that align with healthcare consumers' financial capacities and preferences, utilizing AI-based predictive modeling and optimization algorithms, use AI-driven risk assessment and mitigation techniques to predict and manage potential financial risks associated with individual healthcare consumers and their treatments, and employ AI-powered demand forecasting and supply chain management tools to optimize resource allocation and utilization (i.e. minimize wastage and reduce overall costs). Through AI-driven natural language processing, facilitate transparent communication between healthcare providers, consumers, and insurance companies, enabling informed decision-making and personalized healthcare consumer engagement.

The system 200 uses a combination of artificial intelligence and machine learning techniques to understand various aspects of a healthcare consumer's disposition. For example, the system 200 can use supervised learning to train its machine learning models to predict various outcomes. For instance, the machine learning model(s) can use linear regression to predict continuous variables (e.g., financial variables), such as the cost of treatments or healthcare consumer expenses. The machine learning model(s) can also use logistic regression to predict binary outcomes, such as the likelihood of a healthcare consumer defaulting on medical bills. The machine learning model(s) can also use decision trees and random forests to model complex relationships between healthcare consumer characteristics and financial outcomes, offering interpretable decision-making rules. The machine learning model(s) can also use support vector machines to classify healthcare consumers into different financial risk categories based on their features.

Additionally or alternatively, the system 200 can use unsupervised learning to train its machine learning models to predict various outcomes. For example, the machine learning model(s) can use clustering (e.g., K-means, Hierarchical clustering) to group healthcare consumers' with similar financial profiles, enabling targeted interventions or customized financial plans. The machine learning model(s) can also use principal component analysis (PCA) or t-distributed stochastic neighbor embedding (t-SNE) to reduce the dimensionality of the data and visualize patterns, making it easier to identify trends or outliers in financial diagnostics. The machine learning model(s) can also use anomaly detection to identify unusual patterns or outliers in the data, which can be useful for detecting fraudulent activities or irregular financial transactions.

As further shown in FIG. 2, data can be pulled into the editing service 204 from a raw database 208 that includes information sources from the plurality of healthcare data sources 202, such as the EHR, financial, public SDOH, PBM/Rx, and/or HIE/ADT databases. In some embodiments, data provided to the editing service 204 can be augmented, which can be done manually via a manual data augmentations operation(s) 210, by a human in the loop 212, to provide a prescriptive weighting 214 to the data. Additionally or alternatively, in some embodiments, data provided to the editing service 204 can be automatically augmented and enriched via an automated data augmentation operation(s) 216 and an automated data enrichment operation(s) 218 using natural language processing or other machine learning techniques. In some embodiments, data that is automatically augmented via an automated data augmentation operation(s) 216 via a natural language processing or other machine learning techniques can be pulled from a document data store 220.

The augmented data is then provided to an enriched database 222. The decision management model or execution engine 206 uses the data from the enriched database and performs various machine learning processes or decision algorithms 224 using the enriched data, such as a willingness algorithm, a propensity algorithm, and an ability to spend algorithm. Outputs from the execution engine are stored in an enhanced database 226, and encrypted data from the enhanced database 226 can be accessed by other devices or systems using an API 228. As shown in FIG. 2, various system components can be securely stored within a firewalled system or environment 211, including the raw database 208, the editing service 204, the enriched database 222, the decision management model or execution engine 206, and the enhanced database 226.

In various embodiments, the machine learning model(s) used by the decision management model or execution engine 206 can also use reinforcement learning algorithms, such as Q-learning or Deep Q-Networks (DQN), to optimize decision-making policies in dynamic and uncertain healthcare environments. Overall, the AI-powered system 200 and associated methods can be used for healthcare diagnostics, such as healthcare financial diagnostics, for healthcare individuals to offer a comprehensive and personalized approach to managing aspects of healthcare. By integrating AI and machine learning techniques with healthcare consumer-specific data, commonly prevalent treatment practices, and the associated costs, this innovative decision support system empowers healthcare organizations to make data-driven decisions that optimize patient outcomes while minimizing financial burdens.

Although FIG. 2 illustrates one example of a machine learning diagnostics system 200, various changes may be made to FIG. 2. For example, various components and functions in FIG. 2 may be combined, further subdivided, replicated, or rearranged according to particular needs. Also, one or more additional components and functions may be included if needed or desired. For instance, multiple ones of the components 202, 204, 206, 208, 222, 226, 228 could all be a part of a same server system, such as being a part of one server or multiple servers in a distributed server architecture. In general, computing architectures come in a variety of configurations, and this disclosure is not limited to any particular architecture.

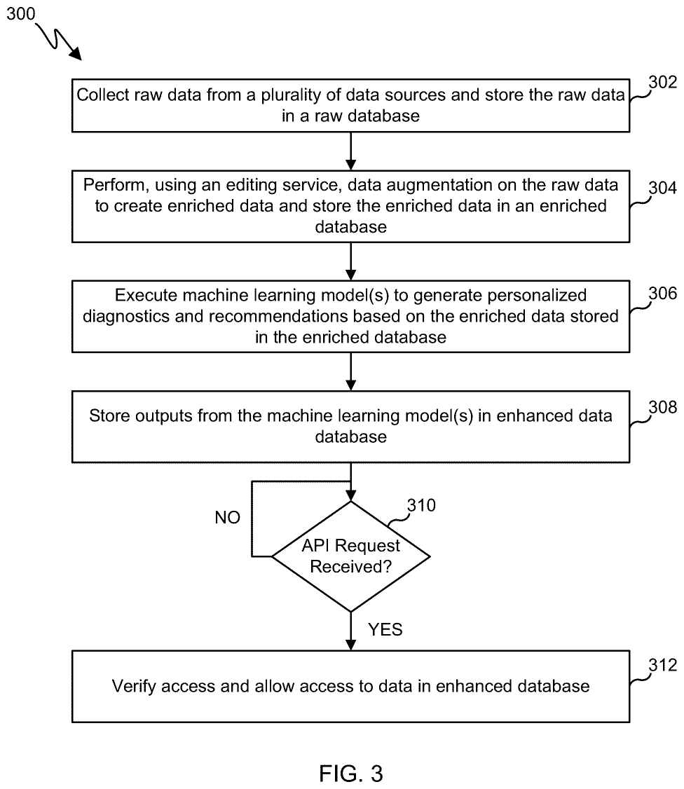

FIG. 3 illustrates an example method 300 for machine learning diagnostics in accordance with this disclosure. For ease of explanation, the method 300 shown in FIG. 3 is described as being performed using the electronic device 101 having at least one processor in the network configuration 100 of FIG. 1. However, the method 300 could be performed using any other suitable device(s), such as the server 106, and in any other suitable system(s).

As shown in FIG. 3, the electronic device 101 collects, or instructs collection of, raw data from a plurality of data sources and the raw data is stored in a raw database. For example, as described with respect to FIG. 2, data can be collected from one or more sources 202 and stored in raw database 208. The data sources can be databases that store collected data/information regarding healthcare consumers (individuals). These data sources databases such as the electronic healthcare records (HER) database 201, the financial database 203, the public social detriments of health (SDOH) database 205, the pharmacy benefit managers and/or prescriptions database 207, and/or the health information exchange (HIE) and/or admissions, discharge, transfer (ADT) database 209. In various embodiments, the data sources can include (i) medical history, demographics, and healthcare insurance information, (ii) commonly prevalent treatment practices, the required resources for these treatments, and the associated costs for these treatments, and (iii) proprietary AI algorithms/models employed to detect patterns and trends in the collected data, allowing for more accurate predictions and personalized (to the healthcare consumer/individual) financial diagnostics.

At step 304, the electronic device performs, or instructs performance of, data augmentation using, for example, an editing service, such as the editing service 204, to create enriched data. The enriched data can be stored in an enriched database, such as the enriched database 222 of FIG. 2. The editing service can provide a user-friendly editing tool to allow healthcare (Provider, Payor, Life Sciences) professionals and administrators to (i) add new information or edit existing information to the above database and (ii) employ AI-driven natural language processing (NLP) techniques to analyze unstructured data, such as medical records, and extract relevant information to be stored in the database. This ensures that the enriched database remains up-to-date and relevant, allowing for accurate financial diagnostics and decision-making.

Data can be pulled into the editing service from the raw database that includes information sources from the plurality of healthcare data sources, such as the EHR, financial, public SDOH, PBM/Rx, and/or HIE/ADT databases. In some embodiments, data provided to the editing service can be augmented, which can be done manually via a manual data augmentations operation(s), such as the manual data augmentations operation(s) 210, by a human in the loop, to provide a prescriptive weighting to the data. Additionally or alternatively, in some embodiments, data provided to the editing service can be automatically augmented and enriched via an automated data augmentation operation(s), such as the automated data augmentation operation(s) 216, and an automated data enrichment operation(s), such as the automated data enrichment operation(s) 218, using natural language processing or other machine learning techniques. In some embodiments, data that is automatically augmented via an automated data augmentation operation(s) via a natural language processing or other machine learning techniques can be pulled from a document data store, such as the document store 220. The augmented data is then provided to the enriched database.

At step 306, the electronic device executes, or instructs execution of, one or more machine learning models to generate personalized diagnostics and recommendations based on the enriched data stored in the enriched database. For example, a decision management service or execution engine, such as a decision management service or execution engine 206 of FIG. 2 can be used to generate the personalized diagnostics and recommendation. In various embodiments, the execution engine is a sophisticated AI-powered model that uses advanced analytics, machine learning algorithms, and AI-driven simulations to analyze the data in the enriched database and generate personalized financial diagnostics and recommendations for each patient. Financial decision support is based on various factors, such as a healthcare consumers' (i) willingness to undergo specific treatments, (ii) ability to spend, and (iii) propensity to adhere to prescribed treatment plans.

The method 300 thus leverages AI and ML techniques to, for example, identify cost-effective treatment options that align with healthcare consumers' financial capacities and preferences, utilizing AI-based predictive modeling and optimization algorithms, use AI-driven risk assessment and mitigation techniques to predict and manage potential financial risks associated with individual healthcare consumers and their treatments, and employ AI-powered demand forecasting and supply chain management tools to optimize resource allocation and utilization (i.e. minimize wastage and reduce overall costs). Through AI-driven natural language processing, facilitate transparent communication between healthcare providers, consumers, and insurance companies, enabling informed decision-making and personalized healthcare consumer engagement.

The method 300 thus can use a combination of artificial intelligence and machine learning techniques to understand various aspects of a healthcare consumer's disposition. In some embodiments, the method 300 can include using supervised learning to train its machine learning models to predict various outcomes. For instance, the machine learning model(s) can use linear regression to predict continuous financial variables, such as the cost of treatments or healthcare consumer expenses. The machine learning model(s) can also use logistic regression to predict binary outcomes, such as the likelihood of a healthcare consumer defaulting on medical bills. The machine learning model(s) can also use decision trees and random forests to model complex relationships between healthcare consumer characteristics and financial outcomes, offering interpretable decision-making rules. The machine learning model(s) can also use support vector machines to classify healthcare consumers into different financial risk categories based on their features.

Additionally or alternatively, the method 300 can include using unsupervised learning to train its machine learning models to predict various outcomes. For example, the machine learning model(s) can use clustering (e.g., K-means, Hierarchical clustering) to group healthcare consumers' with similar financial profiles, enabling targeted interventions or customized financial plans. The machine learning model(s) can also use principal component analysis (PCA) or t-distributed stochastic neighbor embedding (t-SNE) to reduce the dimensionality of the data and visualize patterns, making it easier to identify trends or outliers in financial diagnostics. The machine learning model(s) can also use anomaly detection to identify unusual patterns or outliers in the data, which can be useful for detecting fraudulent activities or irregular financial transactions.

Step 306 can also include using the data from the enriched database and performing various machine learning processes or decision algorithms using the enriched data, such as a willingness algorithm, a propensity algorithm, and an ability to spend algorithm. In various embodiments, the machine learning model(s) can also use reinforcement learning algorithms, such as Q-learning or Deep Q-Networks (DQN), to optimize decision-making policies in dynamic and uncertain healthcare environments. Overall, the method 300 can be used for healthcare diagnostics, such as healthcare financial diagnostics, for healthcare individuals to offer a comprehensive and personalized approach to managing aspects of healthcare. By integrating AI and machine learning techniques with healthcare consumer-specific data, commonly prevalent treatment practices, and the associated costs, this innovative decision support system empowers healthcare organizations to make data-driven decisions that optimize patient outcomes while minimizing financial burdens.

At step 308, the electronic device stores, or instructs storage of, outputs from the machine learning model(s) in an enhanced data database, such as the enhanced database 226 of FIG. 2, and encrypted data from the enhanced data database can be accessed by other devices or systems using an API. At step 310, the electronic device determines if an API request is received. If so, at step 312, the electronic device verifies, or instructs verification of, the access rights of the other devices or systems and allows, or instructs allowance of, the requested access pending the verification.

Although FIG. 3 illustrates one example of a method 300 for machine learning scoring, various changes may be made to FIG. 3. For example, while shown as a series of steps, various steps in FIG. 3 could overlap, occur in parallel, occur in a different order, or occur any number of times (including zero times).

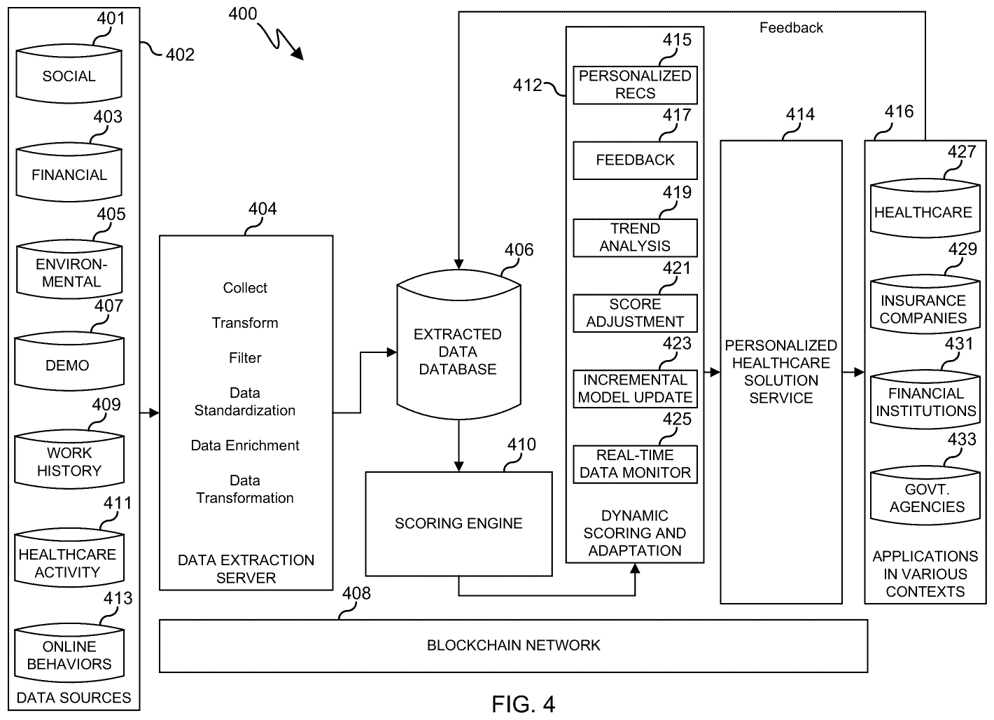

FIG. 4 illustrates an example machine learning healthcare scoring system 400 in accordance with this disclosure. For ease of explanation, the system 400 is described as involving the use of the electronic device 101 in the network configuration 100 of FIG. 1 and/or one or more servers 106. However, the system 400 may be used with any other suitable electronic device(s) and in any other suitable system(s), such as when the system 400 is implemented on or supported by the server 106.

As shown in FIG. 4, in various embodiments, the system 400 is a computerized decision support system for acquiring, normalizing and computing a healthcare scoring model (“willingness score”) for a consumer of healthcare services, based on their social, financial, environmental, demographic, work history, healthcare related activities and other online behaviors. The system leverages advanced AI techniques, blockchain technology, and data organization algorithms to acquire, normalize, and analyze data from various data sources. The system 400 accesses a plurality of data sources 402. The data sources 402 can include one or more social data sources 401, financial data sources 403, environmental data sources 405, demographic data sources 407, work history data sources 409, online behavior data sources 411, and health-related activity data sources 413.

The system 400 further includes a data extraction server 404 that, using the various data sources 402, collects, transforms and/or filters the data, and/or performs data standardization, data enrichment, and/or data transformation on the data. For example, the data extraction server performs data acquisition and normalization by collecting data from the multiple sources and performs data preprocessing techniques such as data cleaning, transformation, and normalization to ensure a consistent format and representation across different sources. The preprocessed data can be stored in an extracted data database 406. The processed data can also be securely stored on a blockchain of a blockchain network 408, ensuring data integrity, immutability, and traceability.

In various embodiments, the extracted data database 406 is used by a scoring engine 410 to score a consumer regarding their healthcare. For example, the scoring model can use deep learning techniques to analyze the collected data and compute the healthcare score for the individual. The model considers a plurality of factors derived from the plurality of sources, such as social, financial, environmental, demographic, work history, healthcare-related activity, and other online behaviors as sourced from the data sources 402. In some embodiments, the model incorporates feature selection techniques, such as Principal Component Analysis (PCA), to identify the most relevant variables contributing to the individual's healthcare financial score. The model can use various machine learning algorithms such as regression analysis or ensemble models, to train the scoring model based on historical data from the data sources, including ground truth data, and identify patterns that influence the individual's willingness score.

As shown in FIG. 4, the system 400, via the scoring engine 410, performs a dynamic scoring and adaption operation(s) 412 by continuously monitoring and updating the consumer's healthcare financial score as new data becomes available, ensuring that the score remains adaptive and responsive to changes in the consumer's circumstances. The dynamic scoring and adaption operation(s) 412 can provide personalized recommendations 415, feedback 417 on consumer circumstances, trend analysis 419, score adjustments 421, incremental model updates 423 based on learning over time, and real-time data monitoring 425. The dynamic scoring and adaption operation(s) 412 thus allows for the identification of trends, patterns, and opportunities for intervention, enabling proactive measures to enhance healthcare financial management.

Using the above information and outputs, the system 400 can provide a personalized healthcare solution generation service 414. For example, based on the computed healthcare financial score, the system can tailor financial solutions, such as loans, insurance plans, or payment options, to the consumer's specific needs and circumstances. The personalized solutions can help improve financial access, affordability, and overall satisfaction with healthcare services.

The AI-driven healthcare scoring system 400 can be applied in various contexts 416, such as healthcare provider contexts 427, insurance companies contexts 429, financial institutions contexts 431, and government agencies contexts 433. By providing a comprehensive and dynamic measure of an individual's healthcare financial situation, the system can help organizations identify areas of improvement, optimize their services, and ultimately enhance the overall healthcare experience for individuals.

Although FIG. 4 illustrates one example of a machine learning scoring system 400, various changes may be made to FIG. 4. For example, various components and functions in FIG. 4 may be combined, further subdivided, replicated, or rearranged according to particular needs. Also, one or more additional components and functions may be included if needed or desired. In general, computing architectures come in a variety of configurations, and this disclosure is not limited to any particular architecture.

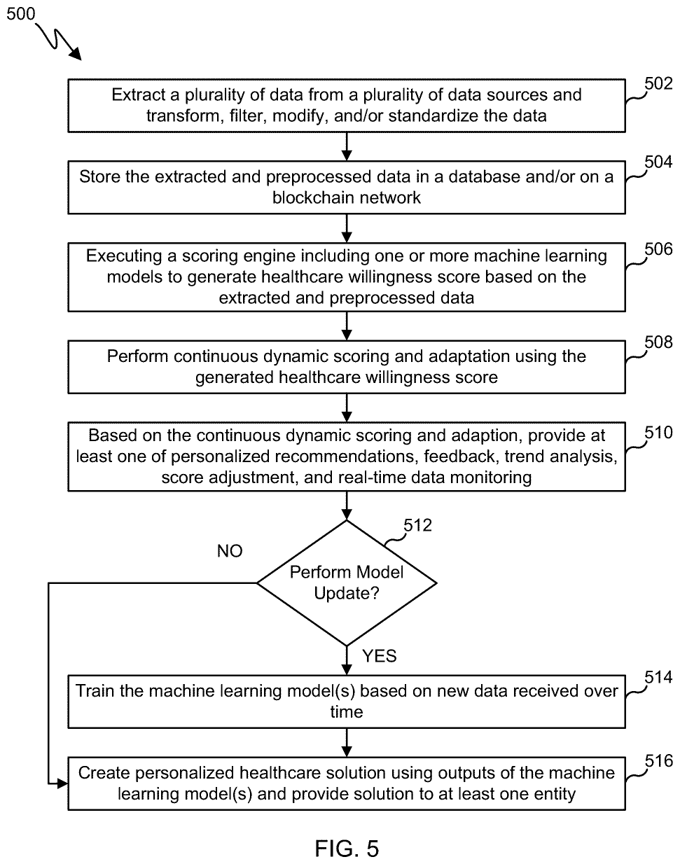

FIG. 5 illustrates an example method 500 for machine learning healthcare scoring in accordance with this disclosure. For ease of explanation, the method 500 shown in FIG. 5 is described as being performed using the electronic device 101 in the network configuration 100 of FIG. 1. However, the method 500 could be performed using any other suitable device(s), such as the server 106, and in any other suitable system(s).

In various embodiments, the method 500 uses a computerized decision support system for acquiring, normalizing and computing a healthcare scoring model (a “willingness score”) for a consumer of healthcare services, based on their social, financial, environmental, demographic, work history, healthcare related activities and/or other online behaviors. The method leverages advanced AI techniques, blockchain technology, and data organization algorithms to acquire, normalize, and analyze data from various data sources. At step 502, the electronic device extracts, or instructs extraction of, a plurality of data from a plurality of data sources and transforms, filters, modifies, and/or standardizes the data. As described with respect to FIG. 4, the data sources can include one or more social data sources 401, financial data sources 403, environmental data sources 405, demographic data sources 407, work history data sources 409, online behavior data sources 411, and health-related activity data sources 413.

In some embodiments, the preprocessing the data is carried out using a data extraction server, such as the data extraction server 404, that, using the various data sources, collects, transforms and/or filters the data, and/or performs data standardization, data enrichment, and/or data transformation on the data. For example, the data extraction server can perform data acquisition and normalization by collecting data from the multiple sources and performs data preprocessing techniques such as data cleaning, transformation, and normalization to ensure a consistent format and representation across different sources. At step 504, the electronic device stores, or instructs storage of, the extracted and preprocessed data in a database and/or on a blockchain network, such as the extracted data database 406 and/or the blockchain network 408.

At step 506, the electronic device executes, or instructs execution of, a scoring engine, such as the scoring engine 410, including one or more machine learning models to generate a healthcare willingness score based on the extracted and preprocessed data. In various embodiments, the extracted data database is used by the scoring engine to score a consumer regarding their healthcare. For example, the scoring model can use deep learning techniques to analyze the collected data and compute the healthcare score for the individual. The model considers a plurality of factors derived from the plurality of sources, such as social, financial, environmental, demographic, work history, healthcare-related activity, and other online behaviors as sourced from the data sources. In some embodiments, the model incorporates feature selection techniques, such as Principal Component Analysis (PCA), to identify the most relevant variables contributing to the individual's healthcare financial score. The model can use various machine learning algorithms such as regression analysis or ensemble models, to train the scoring model based on historical data and identify patterns that influence the individual's willingness score.

At step 508, the electronic device performs, or instructs performance of, continuous dynamic scoring and adaptation using the generated healthcare willingness score. For example, as described with respect to FIG. 4, via the scoring engine, the performance of the dynamic scoring and adaption operation(s) can include continuously monitoring and updating the consumer's healthcare financial score as new data becomes available, ensuring that the score remains adaptive and responsive to changes in the consumer's circumstances. At step 510, the electronic device provides, based on the continuous dynamic scoring and adaptation, personalized recommendations, feedback on consumer circumstances, trend analysis, score adjustments, incremental model updates based on learning over time, and real-time data monitoring. The dynamic scoring and adaption operation(s) thus allows for the identification of trends, patterns, and opportunities for intervention, enabling proactive measures to enhance healthcare financial management.

At step 512, the electronic device determines whether to perform model updates to the scoring model, based on the dynamic scoring and adaption operation(s), such as based on tracked changes to the willingness score over time. If not, the method moves to step 516. If so, at step 514, the electronic device trains, or instructs training of, the one or more machine learning models of the scoring engine based on new data received over time.

At step 516, the electronic device creates, or instructs creation of, a personalized healthcare solution using outputs of the machine learning model(s) and provides a solution to at least one entity. This can include using the personalized healthcare solution generation service 414 of FIG. 4. For example, based on the computed healthcare financial score, the method 500 can tailor financial solutions, such as loans, insurance plans, or payment options, to the consumer's specific needs and circumstances. The personalized solutions can help improve financial access, affordability, and overall satisfaction with healthcare services.

The AI-driven healthcare scoring method 500 can be applied in various contexts, such as healthcare provider contexts, insurance companies contexts, financial institutions contexts, and government agencies contexts. By providing a comprehensive and dynamic measure of an individual's healthcare financial situation, the system can help organizations identify areas of improvement, optimize their services, and ultimately enhance the overall healthcare experience for individuals.

Although FIG. 5 illustrates one example of a method 500 for machine learning scoring, various changes may be made to FIG. 5. For example, while shown as a series of steps, various steps in FIG. 5 could overlap, occur in parallel, occur in a different order, or occur any number of times (including zero times).

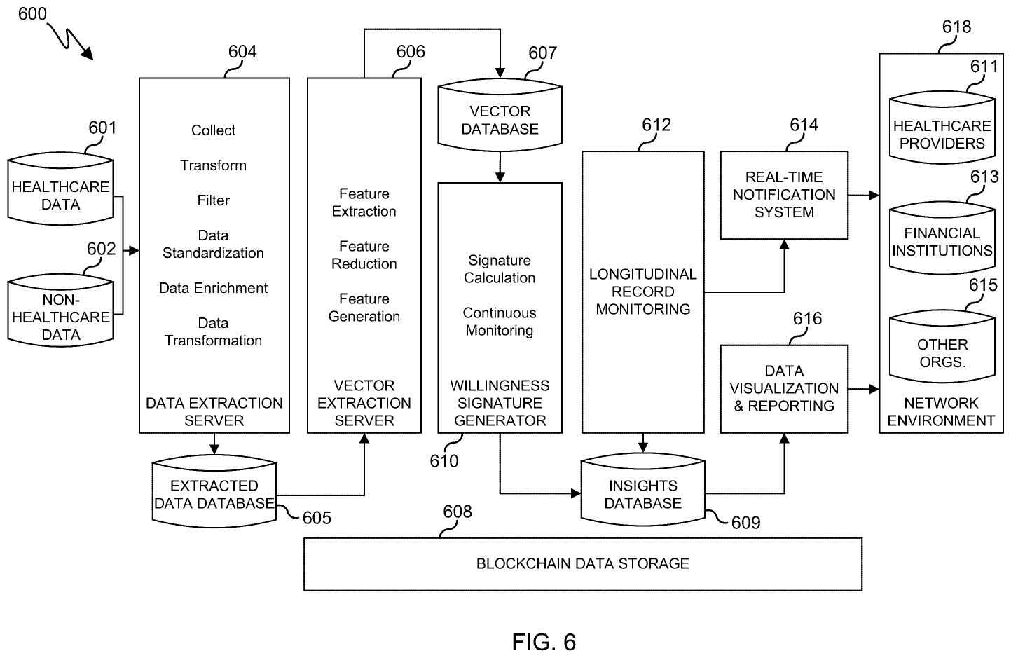

FIG. 6 illustrates an example machine learning healthcare monitoring system 600 in accordance with this disclosure. For ease of explanation, the system 600 is described as involving the use of the electronic device 101 in the network configuration 100 of FIG. 1 and/or one or more servers 106. However, the system 600 may be used with any other suitable electronic device(s) and in any other suitable system(s), such as when the system 600 is implemented on or supported by the server 106.

The system 600 is an AI-driven system using various methods for monitoring healthcare-related data in a network environment. The system 600 integrates blockchain technology, real-time notifications, and advanced data processing techniques to manage and analyze healthcare financial data and non-healthcare financial data associated with a healthcare consumer. As shown in FIG. 6, the system 600 can perform data acquisition and processing using a data extraction server 604 to receive data from various sources, including healthcare data sources 601 such as data from healthcare providers, and non-healthcare data sources 602 such as financial institutions and other relevant organizations. Such data can include healthcare finance data from encounters and non-healthcare financial data associated with the individual. The system converts this data into a financial record of the consumer, which is then securely stored on a blockchain via blockchain data storage 608. The converted data can also be stored in an extracted data database 605.

The system 600 can also perform vector extraction and willingness signature generation using a vector extraction server 606 and a willingness signature generator 610, respectively. Using the vector extraction server 606, the system 600 extracts a plurality of vectors from data, such as financial data, stored in the extracted data database 605 using advanced AI algorithms and data processing techniques. In some embodiments, these vectors can represent various financial aspects, such as spending patterns, healthcare costs, income, insurance coverage, etc. The vectors can be stored in a vector database 607, in various embodiments. Based on the extracted plurality of vectors, the system 600 generates, using the willingness signature generator 610, a willingness signature for the consumer. The willingness signature can be indicative of an individual's financial behavior and preferences in the context of healthcare finance. This process can include performing feature engineering in which the system preprocesses the financial data and extracts relevant features from the raw data. This process also involves advanced AI techniques, such as natural language processing (NLP) for text data and machine learning algorithms for numerical and categorical data. The willingness signature information can be provided to an insights data storage location 609.

The system 600 also can perform dimensionality reduction. Since the financial data may consist of a large number of features, the system applies dimensionality reduction techniques to reduce the complexity of the data and retain only the most relevant features. The system 600 can perform techniques such as Principal Component Analysis (PCA), and/or t-distributed Stochastic Neighbor Embedding (t-SNE), and Autoencoders can be employed to achieve effective dimensionality reduction. The system 600 performs vector representation creation to create a vector representation of the reduced feature set for each individual consumer. Each vector captures the essential aspects of the consumer's financial behavior, preferences, and willingness to engage in healthcare financing activities.

The willingness signature generation via the willingness signature generator 610 utilizes machine learning models, such as supervised or unsupervised learning algorithms, to analyze the vector representations of individual consumers. These models can include classification, clustering, or regression techniques, depending on the desired output. In various embodiments, the machine learning models are trained and validated using historical financial data of consumers with known outcomes. This process ensures the accuracy and reliability of the models in predicting the willingness signatures of consumers. Once the machine learning models are trained and validated, they are used to calculate the willingness signature for each consumer. The willingness signature is a numerical value or a probability distribution that represents the consumer's propensity to engage in healthcare financing activities, based on their financial behavior and preferences. The system 600 is designed to continually learn and update the machine learning models as new data becomes available, ensuring that the willingness signatures remain accurate and up-to-date.

The system 600 also performs longitudinal financial record monitoring operations 612, in which the system 600 continuously monitors the extracted plurality of vectors over time and generates a longitudinal financial record for the consumer. The longitudinal record is a single complete patient record that combines data from a variety of sources throughout the healthcare system. This longitudinal financial record provides insights into the consumer's financial behavior, trends, and changes over an extended period, and information on these insights can be stored in the insights database 609.

The system 600 can also include a real-time notifications system 614 that provides, for example, alerts to relevant parties, such as healthcare providers or financial institutions, of significant events or changes in the consumer's financial record. The system 600 can also perform data visualization and reporting operations 616, in which the system 600 can display the financial record, willingness signature, and longitudinal financial record of the consumer in an intuitive and user-friendly manner. Customizable dashboards, charts, and reports can be generated to facilitate data analysis and decision-making for various parties in one or more network environments 618, such as healthcare providers 611, financial institutions 613, and other organizations 615, such as insurers and/or the consumers themselves.

Although FIG. 6 illustrates one example of a machine learning healthcare monitoring system 600, various changes may be made to FIG. 6. For example, various components and functions in FIG. 6 may be combined, further subdivided, replicated, or rearranged according to particular needs. Also, one or more additional components and functions may be included if needed or desired. In general, computing architectures come in a variety of configurations, and this disclosure is not limited to any particular architecture.

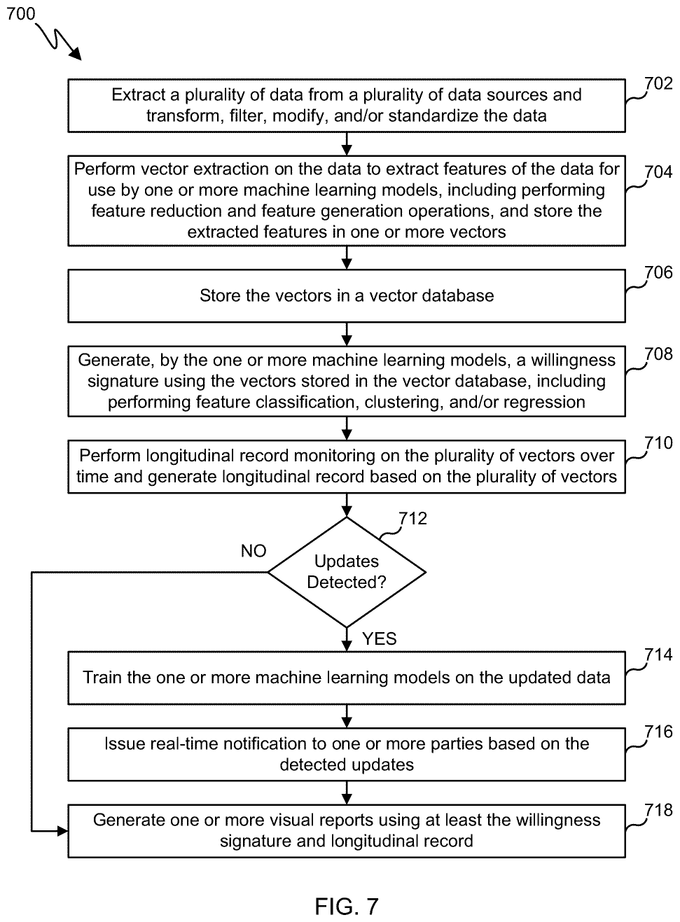

FIG. 7 illustrates an example method 700 for machine learning healthcare monitoring in accordance with this disclosure. For ease of explanation, the method 700 shown in FIG. 7 is described as being performed using the electronic device 101 in the network configuration 100 of FIG. 1. However, the method 700 could be performed using any other suitable device(s), such as the server 106, and in any other suitable system(s).

The method 700 is an AI-driven method using various techniques for monitoring healthcare-related data in a network environment. The method 700 integrates blockchain technology, real-time notifications, and advanced data processing techniques to manage and analyze healthcare financial data and non-healthcare financial data associated with a healthcare consumer. As shown in FIG. 7, at step 702, the electronic device extracts, or instructs extraction of, data from a plurality of data sources and transforms, filters, modifies, and/or standardizes the data. This can include using the data extraction server 604 of FIG. 6. In some embodiments, the data sources can be healthcare data sources such as data from healthcare providers, and non-healthcare data sources such as financial institutions and other relevant organizations. Such data can include healthcare finance data from encounters and non-healthcare financial data associated with the individual. The method converts this data into a financial record of the consumer, which is then securely stored on a blockchain, such as the blockchain data storage 608. The converted data can also be stored in a database, such as the extracted data database 605.

At step 704, the electronic device performs, or instructs performance of, vector extraction, such as via the vector extraction server 606 of FIG. 6, to extract features of the data for use by one or more machine learning models, including performing feature reduction and feature generation operations, and storing the extracted features as one or more vectors. This can include extracting the plurality of vectors from data, such as financial data, such as stored in the extracted data database, using advanced AI algorithms and data processing techniques. In some embodiments, these vectors can represent various financial aspects, such as spending patterns, healthcare costs, income, insurance coverage, etc. At step 706, the electronic device stores, or instructs storage of, the vectors in a vector database, such as vector database 607.

At step 708, the electronic device generates, or instructs generation of, using one or more machine learning models and the vectors stored in the vector database, a willingness signature. This can involve using the willingness signature generator 610 of FIG. 6. This can also include, performing features classification, clustering, and or regression. The willingness signature can be indicative of an individual's financial behavior and preferences in the context of healthcare finance. This process can include performing feature engineering in which the system preprocesses the financial data and extracts relevant features from the raw data. This process also involves advanced AI techniques, such as natural language processing (NLP) for text data and machine learning algorithms for numerical and categorical data. As shown in FIG. 6, the willingness signature information can be provided to an insights data storage location 609.

In some embodiments, the method 700 also includes performing dimensionality reduction. Since the financial data may consist of a large number of features, the method can apply dimensionality reduction techniques to reduce the complexity of the data and retain only the most relevant features. The method can also perform techniques such as Principal Component Analysis (PCA), and/or t-distributed Stochastic Neighbor Embedding (t-SNE), and Autoencoders can be employed to achieve effective dimensionality reduction. The method 700 can also perform vector representation creation to create a vector representation of the reduced feature set for each individual consumer. Each vector captures the essential aspects of the consumer's financial behavior, preferences, and willingness to engage in healthcare financing activities.

The willingness signature generation utilizes machine learning models, such as supervised or unsupervised learning algorithms, to analyze the vector representations of individual consumers. In various embodiments, the machine learning models are trained and validated using historical financial data of consumers with known outcomes. This process ensures the accuracy and reliability of the models in predicting the willingness signatures of consumers. Once the machine learning models are trained and validated, they are used to calculate the willingness signature for each consumer. In various embodiments, the willingness signature is a numerical value or a probability distribution that represents the consumer's propensity to engage in healthcare financing activities, based on their financial behavior and preferences. The method 700 can thus continually learn and update the machine learning models as new data becomes available, ensuring that the willingness signatures remain accurate and up-to-date.

At step 710, the electronic device performs, or instructs performance of, longitudinal record monitoring on the plurality of vectors over time and generate longitudinal record based on the plurality of vectors. This can include continuously monitoring the extracted plurality of vectors over time and generating a longitudinal financial record for the consumer. This longitudinal financial record provides insights into the consumer's financial behavior, trends, and changes over an extended period, and information on these insights can be stored in the insights database 609.

At step 712, the electronic device determines whether updates are detected based on the record monitoring. If not, the method 700 moves to step 718. If so, at step 714, the electronic device trains, or instructs training of, the one or more machine learning models using the updated data. At step 716, the electronic device issues, or instructs issuance of, a real-time notification to one or more parties based on the detected updates. This can include using the real-time notifications system 614 of FIG. 6 that provides, for example, alerts to relevant parties, such as healthcare providers or financial institutions, of significant events or changes in the consumer's financial record.

At step 718, the electronic device generates, or instructs generation of, one or more visual reports using at least the willingness signature and longitudinal record. This can involve displaying the financial record, willingness signature, and longitudinal financial record of the consumer in an intuitive and user-friendly manner. Customizable dashboards, charts, and reports can be generated to facilitate data analysis and decision-making for various parties in one or more network environments, such as healthcare providers, financial institutions, and other organizations, such as insurers and/or the consumers themselves.

Although FIG. 7 illustrates one example of a method 700 for machine learning healthcare monitoring, various changes may be made to FIG. 7. For example, while shown as a series of steps, various steps in FIG. 7 could overlap, occur in parallel, occur in a different order, or occur any number of times (including zero times).

It will be understood that the systems 200, 400, and 600 can be used as separate systems or combined and included as part of a single system/platform and can perform the methods facilitated by the system described herein. In general, the systems 200, 400, and 600 can be used cooperatively to provide for a comprehensive system for performing predictive analysis and monitoring using machine learning models.

Although this disclosure has been described with example embodiments, various changes and modifications may be suggested to one skilled in the art. It is intended that this disclosure encompass such changes and modifications as fall within the scope of the appended claims.

What is claimed is:

1. A system comprising:
at least one device configured to extract data from at least one internet-connected data source and preprocess the extracted data, including performance of one or more of a transformation of the extracted data, a filtering of the extracted data, a modification of the extracted data, and a standardization of the extracted data;
a database configured to store the preprocessed data; and
at least one processor configured to:
perform vector extraction to extract features of at least a portion of the preprocessed data and generate a plurality of vectors from the extracted features of the preprocessed data;
input the plurality of vectors into a machine learning model trained using historical data from the at least one internet-connected data source; and
generate, using the machine learning model and the plurality of vectors, a willingness signature associated with an individual, wherein the willingness signature is a numerical value or a probability distribution that represents a propensity of the individual to engage in healthcare-related activities.

2. The system of claim 1, wherein the at least one processor is further configured to:
perform longitudinal record monitoring on the plurality of vectors over time; and
generate a longitudinal record of the individual based on the longitudinal record monitoring.

3. The system of claim 2, wherein the at least one processor is further configured to:
detect, based on the longitudinal record monitoring, updates to the plurality of vectors; and
retrain the machine learning model using the updates to the plurality of vectors.

4. The system of claim 3, wherein the at least one processor is further configured to issue a real-time notification to one or more third parties based on the detected updates to the plurality of vectors.

5. The system of claim 2, further comprising a network connection between the at least one processor and another device that allows the other device to request access to the willingness signature and the longitudinal record, wherein the at least one processor is further configured to:
receive a request by the other device to access the longitudinal record; and
generate a visual display of the longitudinal record and the willingness signature to the other device.

6. The system of claim 5, wherein the at least one processor is further configured to:
provide to the other device, using the willingness signature, one or more of personalized recommendations, feedback, trend analysis, score adjustments, and real-time data monitoring updates.

7. The system of claim 1, wherein the at least one processor is further configured to cause the preprocessed data to be stored using a blockchain network.

8. The system of claim 1, wherein the preprocessing of the extracted data includes using a natural language processing model having access to a document data store to perform automated data augmentation and data enrichment on the extracted data.

9. The system of claim 1, wherein, to generate the willingness signature, the machine learning model is configured to perform at least one of feature classification, data clustering, and linear or logistic regression.

10. A method comprising:
extracting data from at least one internet-connected data source and preprocessing the extracted data, including performing one or more of a transformation of the data, a filtering of the data, a modification of the data, and a standardization of the data;
storing the preprocessed data in a database;
performing vector extraction to extract features of at least a portion of the preprocessed data and generating a plurality of vectors from the extracted features of the preprocessed data;
inputting the plurality of vectors into a machine learning model trained using historical data from the at least one internet-connected data source; and
generating, using the machine learning model and the plurality of vectors, a willingness signature associated with an individual, wherein the willingness signature is a numerical value or a probability distribution that represents a propensity of the individual to engage in healthcare-related activities.

11. The method of claim 10, further comprising:
performing longitudinal record monitoring on the plurality of vectors over time; and
generating a longitudinal record of the individual based on the longitudinal record monitoring.

12. The method of claim 11, further comprising:
detecting, based on the longitudinal record monitoring, updates to the plurality of vectors; and
retraining the machine learning model using the updates to the plurality of vectors.

13. The method of claim 12, further comprising issuing a real-time notification to one or more third parties based on the detected updates to the plurality of vectors.

14. The method of claim 11, further comprising:
allowing a device to request access to the willingness signature and the longitudinal record via a network connection;
receiving a request by the device to access the longitudinal record; and
generating a visual display of the longitudinal record and the willingness signature to the device.

15. The method of claim 14, further comprising:
providing to the device, using the willingness signature, one or more of personalized recommendations, feedback, trend analysis, score adjustments, and real-time data monitoring updates.

16. The method of claim 10, further comprising causing the preprocessed data to be stored using a blockchain network.

17. The method of claim 10, wherein the preprocessing of the extracted data includes using a natural language processing model having access to a document data store to perform automated data augmentation and data enrichment on the extracted data.

18. The method of claim 10, wherein generating the willingness signature includes performing, using the machine learning model, at least one of feature classification, data clustering, and linear or logistic regression.

19. A system comprising:
at least one device configured to extract data from at least one internet-connected data source and preprocess the extracted data, including performance of one or more of a transformation of the extracted data, a filtering of the extracted data, a modification of the extracted data, and a standardization of the extracted data, wherein the preprocessing of the extracted data includes using a natural language processing model having access to a document data store to perform automated data augmentation and data enrichment on the extracted data;
a database configured to store the preprocessed data; and
a network connection between at least one processor and another device,
the at least one processor configured to:
cause the preprocessed data to be stored using a blockchain network;
perform vector extraction to extract features of at least a portion of the preprocessed data and generate a plurality of vectors from the extracted features of the preprocessed data;
input the plurality of vectors into a machine learning model trained using historical data from the at least one internet-connected data source;
generate, using the machine learning model and the plurality of vectors, a willingness signature associated with an individual, wherein the willingness signature is a numerical value or a probability distribution that represents a propensity of the individual to engage in healthcare-related activities, wherein to generate the willingness signature, the machine learning model is configured to perform at least one of feature classification, data clustering, and linear or logistic regression;
perform longitudinal record monitoring on the plurality of vectors over time;
generate a longitudinal record of the individual based on the longitudinal record monitoring;
detect, based on the longitudinal record monitoring, updates to the plurality of vectors;
retrain the machine learning model using the updates to the plurality of vectors;
issue a real-time notification to one or more third parties based on the detected updates to the plurality of vectors;
receive, via the network connection, a request by the other device to access the longitudinal record;
generate a visual display of the longitudinal record and the willingness signature to the other device; and
provide to the other device, using the willingness signature, one or more of personalized recommendations, feedback, trend analysis, score adjustments, and real-time data monitoring updates.

20. The system of claim 19, wherein the at least one processor is further configured to:
determine a health threshold value based on the longitudinal record;
monitor the health of the individual via a determination of whether a current status of the individual is within a range between the health threshold value and a lower limit; and
inform the other device of the current status of the individual when it is determined that the current status is within the range between the health threshold value and the lower limit.
